(19) United States
(12) Patent Application Publication
(10) Pub. No.: US 2017/0147320 A1
(43) Pub. Date: May 25, 2017

(54) A NETWORK NODE, A DEVICE AND METHODS THEREIN FOR DETERMINING INTEROPERABILITY OF SOFTWARE WITH THE DEVICE

(71) Applicant: TELEFONAKTIEBOLAGET LM ERICSSON (PUBL), Stockholm (SE)

(72) Inventors: Per Persson, Sodra Sandby (SE); Patrik Ekdahl, Dalby (SE)

(21) Appl. No.: 14/439,258

(22) PCT Filed: Apr. 23, 2015
(86) PCT No.: PCT/EP2015/058807

§ 371 Date: Apr. 29, 2015

(51) Int. Cl. G06F 9/445; G06F 11/36

(52) U.S. Cl. CPC G06F 8/65; G06F 11/3664; G06F 11/3688; G06F 11/3684

(57) ABSTRACT

A method performed by a network node for determining interoperability of an updated version of a piece of software with a device. The network node and the device operate in a network. The network node obtains information about software and hardware comprised in the device. The software comprises the piece of software to be updated. The network node updates the information about software and hardware with the updated version of the piece of software. The network node determines the interoperability of the updated version of the piece of software with the device based on a result of an interoperability test of the piece of software in an emulated environment corresponding to the device and created using updated information about software and hardware comprised in the device.

### TECHNICAL FIELD

Embodiments herein relate to a network node, a device and methods therein. In particular they relate to determining interoperability of software with the device.

### BACKGROUND

The Internet of Things (IoT) is a network of physical objects or “things” embedded with electronics, software, sensors and connectivity to enable it to achieve greater value and service by exchanging data with the manufacturer, operator and/or other connected devices. Each thing is uniquely identifiable through its embedded computing system but is able to interoperate within the existing Internet infrastructure.

IoT is expected to offer advanced connectivity of devices, systems, and services that goes beyond Machine-to-Machine communications (M2M) and covers a variety of protocols, domains, and applications. The interconnection of these embedded devices, including smart objects, is expected to usher in automation in nearly all fields, while also enabling advanced applications.

Things, in the IoT, may refer to a wide variety of devices such as heart monitoring implants, biochip transponders on farm animals, electric clams in coastal waters, automobiles with built-in sensors, or field operation devices that assist fire-fighters in search and rescue. These devices collect useful data with the help of various existing technologies and then autonomously flow the data between other devices. Current market examples include smart thermostat systems and washer/dryers that utilize Wi-Fi for remote monitoring.

The ability to network embedded devices with limited CPU, memory and power resources means that IoT finds applications in nearly every field. Such systems may be in charge of collecting information in settings ranging from natural ecosystems to buildings and factories, thereby finding applications in fields of environmental sensing and urban planning.

As the Internet of Things forms, encompassing a vast number of devices, there will also be an increased management problem of the software versions and the patches, i.e. the set of changes to be applied to source code or a binary image, running on these devices. It will not only be a problem of maintaining the proprietary application that runs on the device, but it will also be a problem of updating the operating system and support libraries to the application.

From a cost-efficiency perspective, it is anticipated that custom-built applications running on these devices will utilize more and more third party and open source libraries. This has benefits but also puts the application developer in the hands of open source developer communities that evolve their software in ways the application provider cannot always predict or influence. This may lead to incompatibility problems between versions of the software, i.e. a new version of software, such as a new version of a library, may not be backwards compatible. Already today some applications require very specific versions of some library to function correctly. It may also be an inter-library version incompatibility problem where specific combinations of library versions do not function correctly together.

Also from the perspective to protect the device from attacks, it is essential that operating system patches and new versions of libraries be applied at regular intervals. To a homeowner with some twenty, thirty devices it will be diligent work just keep up with the new releases. If we add to that the complexity of different none-interoperable versions of software, the burden will be too heavy and the result will be a network of old unpatched devices.

There are currently two major approaches to software management: package managers, e.g. apt for the operative system Debian, Apple's AppStore and SoftwareUpdate, and container approaches, e.g. Docker or Rocket.

Package managers provide a set of staged software that is easily installed on user devices. When a piece of software is updated, the community around the package manager will test the updated software on as many platforms as possible before adding the updated component to the stage seen by the public. Unfortunately, this adds a delay in time which might sometimes be significant, particularly in the case of fixes for critical security problems. Furthermore, due to the vast number of combinations of platforms and installed software, only a fraction of those may actually be tested.

An opposite approach to package managers is taken by containerized application distribution through systems like Docker. In this case the full software stack, i.e. the application and all its dependencies, used by the developer is replicated on the user device. Every application and its dependencies are isolated from other applications and their dependencies, solving the problem of incompatibilities. This approach has drawbacks in terms of large persistent and volatile storage capacity. This is particularly a drawback for resource limited systems or devices.

### SUMMARY

An object of embodiments herein is to improve the updating of software in a device.

According to a first aspect of embodiments herein, the object is achieved by a method performed by a network system for determining interoperability of an updated version of a piece of software with a device. The network system and the device operate in a network. The network system comprises a network node and a test server. The test server may be comprised in the network node.

The network node obtains information about software and hardware comprised in the device. The software comprises the piece of software to be updated. The network node obtains information about the updated version of the piece of software.

The test server performs an interoperability test of the piece of software in an emulated environment corresponding to the device and created using updated information about software and hardware comprised in the device. The network node determines the interoperability of the updated version of the piece of software with the device based on a result of the interoperability test.

According to a second aspect of embodiments herein, the object is achieved by a network system for determining interoperability of an updated version of a piece of software with a device. The network system and the device are configured to operate in a network. The network system comprises a network node and a test server. The test server may be comprised in the network node.

The network node is configured to obtain information about software and hardware comprised in the device, which software comprises the piece of software to be updated.

The network node is configured obtain information about the updated version of the piece of software

The test server is configured to perform an interoperability test of the piece of software in an emulated environment corresponding to the device and created using updated information about software and hardware comprised in the device.

The network node is configured to determine the interoperability of the updated version of the piece of software with the device based on a result of the interoperability test.

According to a third aspect of embodiments herein, the object is achieved by a method performed by a network node for determining interoperability of an updated version of a piece of software with a device. The network node and the device operate in a network.

The network node obtains information about software and hardware comprised in the device. The software comprises the piece of software to be updated.

The network node updates information about software and hardware with information about the updated version of the piece of software.

The network node determines the interoperability of the updated version of the piece of software with the device based on a result of an interoperability test of the piece of software in an emulated environment corresponding to the device and created using updated information about software and hardware comprised in the device.

According to a fourth aspect of embodiments herein, the object is achieved by a network node for determining interoperability of an updated version of a piece of software with a device. The network node and the device are configured to operate in a network.

The network node is configured to obtain information about software and hardware comprised in the device. The software comprises the piece of software to be updated.

The network node is configured to update information about software and hardware with information about the updated version of the piece of software.

The network node is configured to determine the interoperability of the updated version of the piece of software with the device based on a result of an interoperability test of the piece of software in an emulated environment corresponding to the device and created using updated information about software and hardware comprised in the device.

According to a fifth aspect of embodiments herein, the object is achieved by a method performed by a device for assisting a network node in determining interoperability of an updated version of a piece of software with the device. The network node and the device operate in a network.

The device provides to the network node, information about software and hardware, each comprised in the device. The software comprises the piece of software to be updated. With the information the network node is able to determine the interoperability of the updated version of the piece of software with the device based on a result of an interoperability test of the piece of software in an emulated environment corresponding to the device and created using updated information about software and hardware comprised in the device.

According to a sixth aspect of embodiments herein, the object is achieved by a device for assisting a network node in determining interoperability of an updated version of a piece of software with the device. The network node and the device are configured to operate in a network.

The device is configured to provide information about software, which software comprises the piece of software to be updated, and hardware, each comprised in the device, to the network node. With the information the network node is able to determine the interoperability of the updated version of the piece of software with the device based on a result of an interoperability test of the piece of software in an emulated environment corresponding to the device and created using updated information about software and hardware comprised in the device.

According to a seventh aspect of embodiments herein, the object is achieved by a computer program, comprising instructions that, when executed on at least one processor, cause the at least one processor to carry out any one of the methods above.

According to an eight aspect of embodiments herein, the object is achieved by a carrier comprising the computer program mentioned above, wherein the carrier is one of an electronic signal, optical signal, radio signal, or computer readable storage medium.

The determination of the interoperability of the piece of software with the device is improved since the network node determines the interoperability based on the result of the interoperability test of the piece of software in the emulated environment. The improved determination of the interoperability improves the updating of the piece of software in the device.

An advantage with embodiments herein is that they maintain an up-to-date and secure system of software in the device, free of incompatibility conflicts, without paying a premium in terms of persistent and/or volatile storage requirements.

Embodiments herein ensure compatibility when libraries and other third-party software are updated, before they are actually deployed to the device by testing the updated software in an emulated environment corresponding to the device. Testing the updated software in an emulated environment corresponding to the device is advantageous compared to e.g. using package managers since the actual combination of software and hardware is tested in a short time.

Furthermore, embodiments herein off-load power constrained devices to regularly check for software updates.

### BRIEF DESCRIPTION OF THE DRAWINGS

Examples of embodiments herein are described in more detail with reference to attached drawings in which:

FIG. 1a is a combined schematic block diagram and flowchart illustrating devices in a network and a method of updating software in the devices according to prior art.

FIG. 1b is a combined schematic block diagram and flowchart illustrating embodiments of a method in a network.

FIG. 1c is a combined schematic block diagram and flowchart illustrating embodiments of a method in a network.

FIG. 2 is a combined signalling diagram and flowchart illustrating embodiments of a method in a network.

FIG. 3 is a flow chart illustrating embodiments of a method performed by a network node.

FIG. 4 is a schematic block diagram illustrating embodiments of a network node.

FIG. 5 is a flow chart illustrating embodiments of a method performed by a device.

FIG. 6 is a schematic block diagram illustrating embodiments of a device.

### DETAILED DESCRIPTION

As part of developing embodiments herein, a problem will first be identified and discussed.

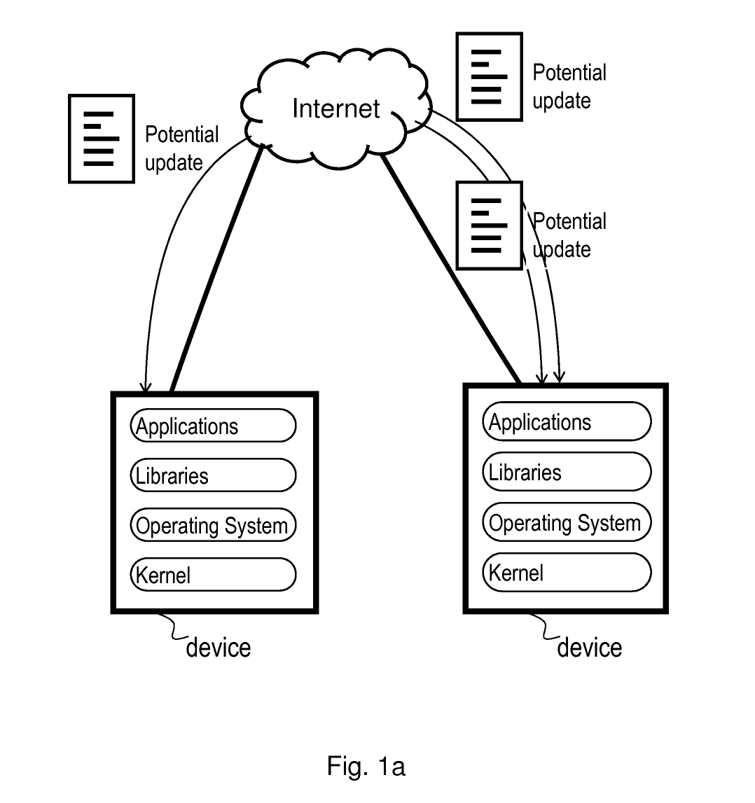

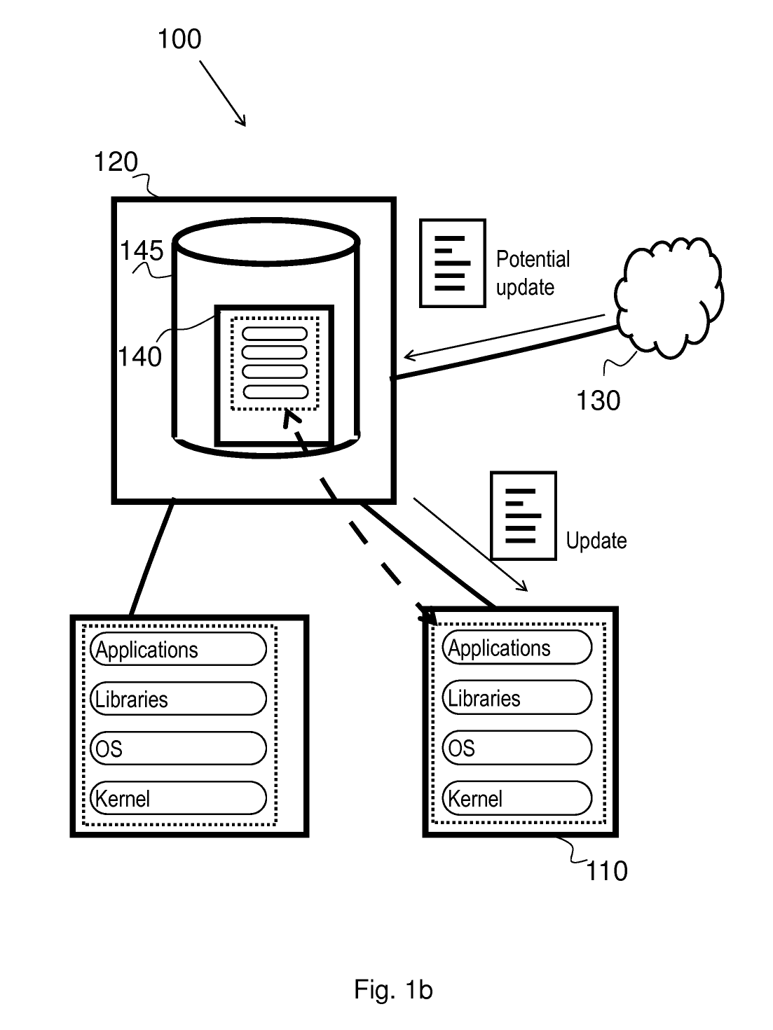

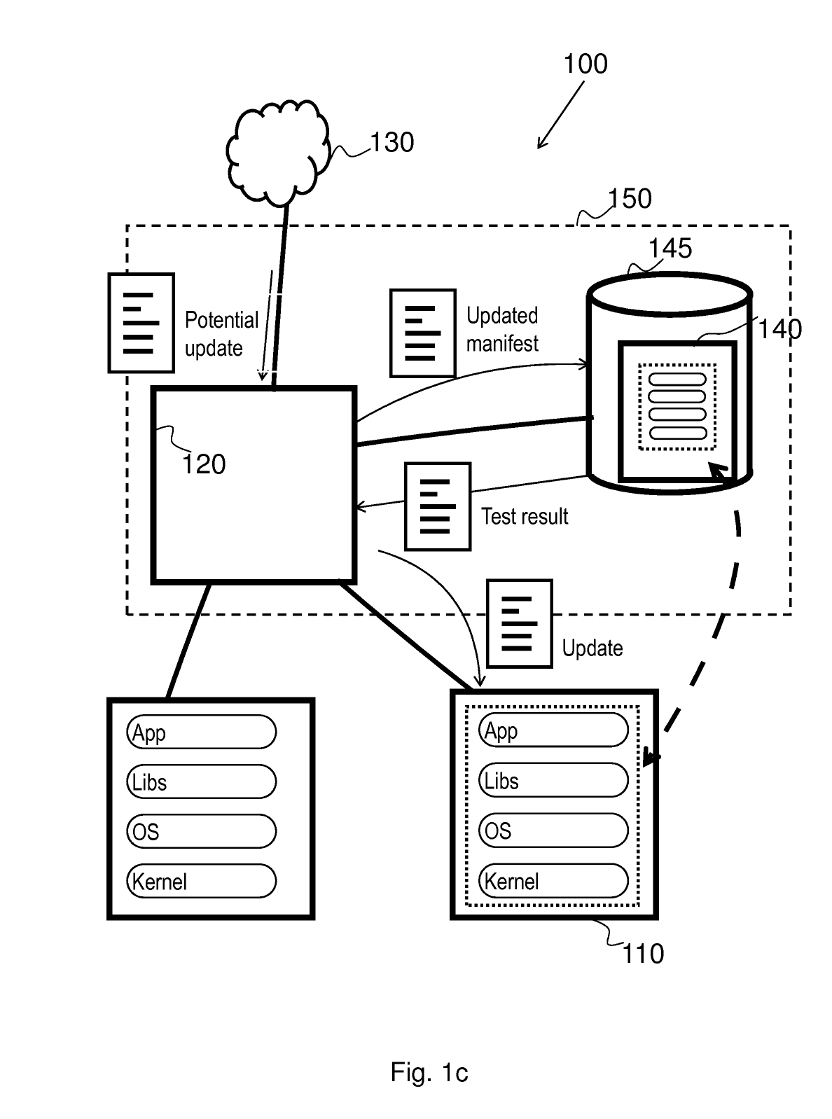

Today, many of the home network devices that are powered “from the wall” are able to contact their manufacturer and ask for software updates for their software such as applications, libraries, Operative System (OS), kernel, etc., as depicted in FIG. 1a. This works fine since the power supply is not restricted. In a battery powered IoT device setting, there are much higher constraints on how often a communication link, such as a radio interface, may be used, in order not to drain the batteries of the IoT device or to require a battery re-charging. From a power saving perspective, it is imperative to minimize the radio traffic transmitted and received from these devices.

Embodiments herein out-source the maintenance responsibility for updating software to a network node, also referred to as a portal. The portal, which may be wall-powered, is part of the network comprising the devices and also has an interface to an external network, such as the Internet.

Embodiments herein relate to networks of devices, such as IoT. FIG. 1b is a schematic overview depicting a network 100, such as a radio based network. Such a radio based network may e.g. be a telecommunications network or similar. The network 100 may use a number of different technologies, such as Wi-Fi, Zigbee, Bluetooth, Bluetooth Low Energy (BLE), Long Term Evolution (LTE), LTE-Advanced, Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible implementations. The network 100 is exemplified herein as a local radio based network. The local network may for example be a home network.

The network 100 comprises a multitude of devices which are in need of updating their software from time to time. In particular the network comprises a device 110. Thus the device 110 is configured to operate in the network 100. It should be understood by the skilled in the art that “device” is a non-limiting term which means any mobile station, wireless device, wireless terminal, user equipment, Machine Type Communication (MTC) device, a Device to Device (D2D) terminal, or node e.g. Personal Digital Assistant (PDA), laptop, mobile, sensor, automation device, relay, mobile tablets or even a small base station communicating within a cell.

In particular, the device 110 may be constrained or restricted in power. The device 110 may for example be a device that is not wall-powered. E.g. the device 110 may be powered by constrained power sources such as batteries or solar powered or kinetically powered. The device 110 may further be difficult to re-charge.

An example of a device that is difficult to re-charge is an embedded device. An embedded device is a highly specialized device meant for one or very few specific purposes and is usually embedded or included within another object or as part of a larger system. Usually, the device is part of a system that serves a greater purpose, for example, a heart rate monitor embedded in a wristwatch that may connect to a smart phone to display the heart's status in real time or an accelerometer embedded in shoes to monitor speed, distance traveled and calories burned. Point of Sales Terminals (POS) and Automated Teller Machines (ATM) are also examples of embedded devices or systems.

The network 100 further comprises a network node 120 which is connectable to the device 110 and to an external network 130. The network node 120 is thus configured to operate in the network 100. The external network 130 may for example be the Internet.

The network node 120 may in contrast to the device 110 be wall-powered and/or easily re-chargeable, e.g. from a wall outlet. That is, the network node may get its energy from a continuous power supply. The network node 120 may also be referred to as a portal.

The network node 120 may be obtained such as e.g. bought by an end user of the device 110 or may be bundled free with a modem provided by most Internet Service Providers (ISPs). The incentive for the ISP to provide the network node 120 and the service delivered by the network node 120 as described below may be to prevent malicious code and hacked devices in their network. It is likely that hacked devices may generate unwanted traffic in the network and hence it is of importance for the ISP to keep all the devices connected to their network clean. Also, it may be seen as a business differentiator for the ISP to provide the network node 120 and the following service to their customers.

The network node 120 may be responsible for collecting information about the devices, such as the device 110, comprised in the network 100 and may keep track of these devices. For example, the network node 120 may be responsible for checking software updates for the devices comprised in the network 100. The network node 120 may build an internal list of the software that the devices are running and may check open-source repositories and software vendor sites for new and/or updated software. The checking for updated software may be performed periodically, for example at some predetermined interval.

The network node 120 may have some kind of management interface, e.g. a web-server, opened on the network 100.

In some embodiments, such as the one depicted in FIG. 1b, the network node 120 comprises an emulated environment which may comprise an emulated hardware platform 140 corresponding to the hardware comprised in the device 110 and onto which emulated hardware platform 140 software comprised in the device 110 is loaded. The dashed line with arrows in FIG. 1b indicates that software loaded onto the hardware platform 140 corresponds to software in the device 110. The emulated environment may be implemented by a test server 145. The emulated hardware platform 140 may be run, with the aid of a hypervisor, on the test server's 145 hardware. The test server 145 may test the interoperability of updated software with the device 110.

In some other embodiments, depicted in FIG. 1c, the network node 120 does not comprise the emulated environment, such as the test server 145. Then the test server 145 and the network node 120 may be connectable to each other and comprised in a network system 150. For example, the test server 145 may be cloud based.

It should be noted that the following embodiments are not mutually exclusive. Components from one embodiment may be tacitly assumed to be present in another embodiment and it will be obvious to a person skilled in the art how those components may be used in the other exemplary embodiments.

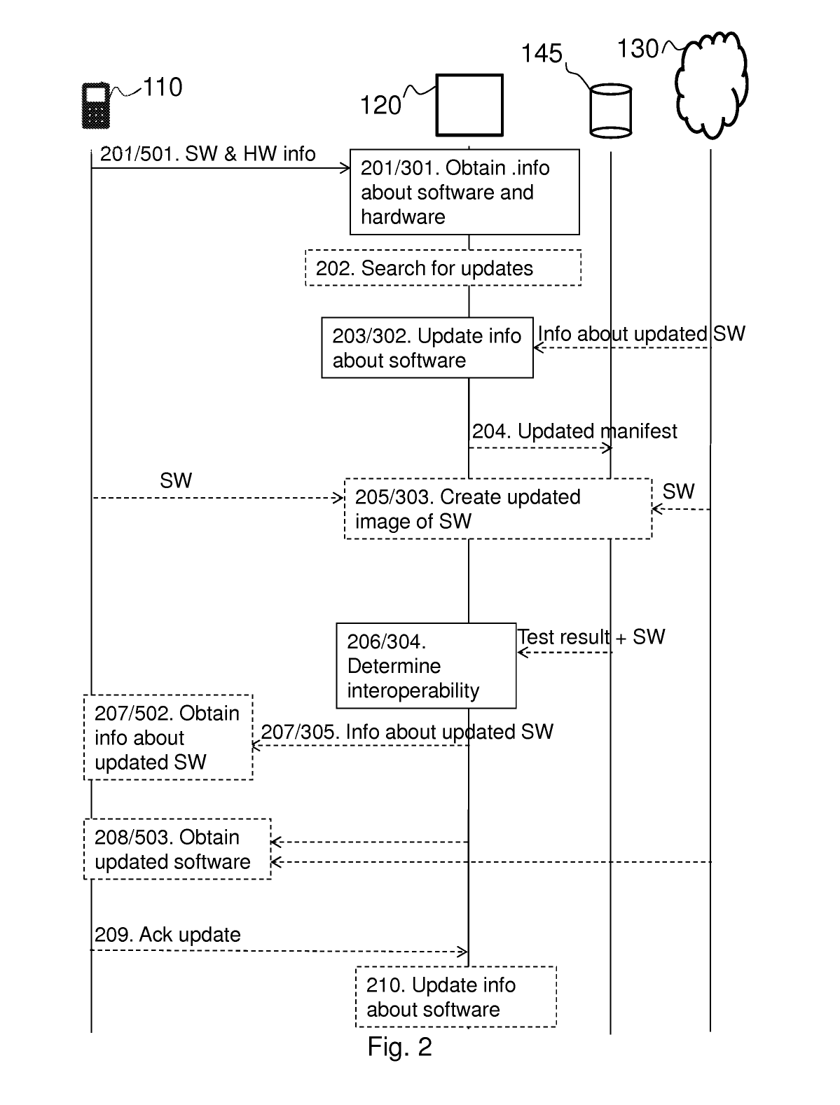

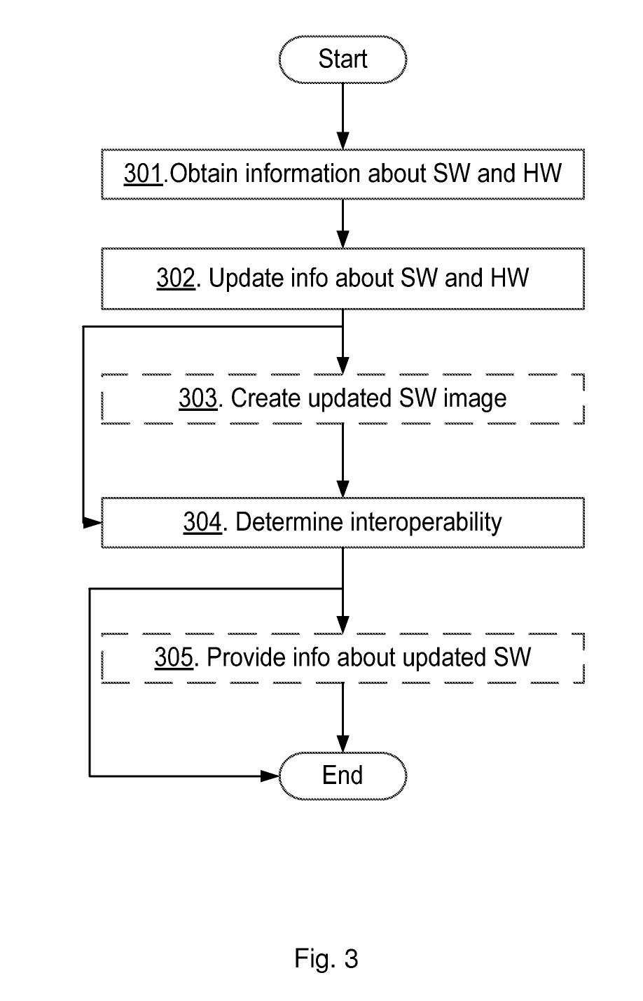

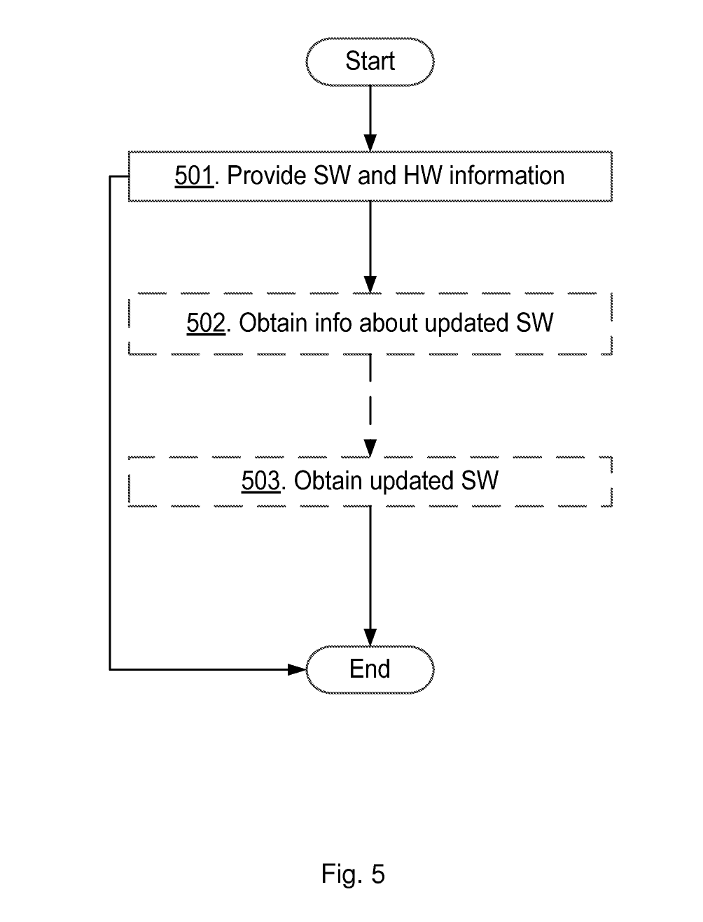

Actions for determining interoperability of an updated version of a piece of software with the device 110 in the network 100 according to embodiments herein will now be described in relation to FIG. 2, FIG. 3 and FIG. 5.

FIG. 2 is a combined signalling diagram and flow chart that describes a method for determining interoperability of the updated version of the piece of software with the device 110 according to embodiments herein.

FIG. 3 is a flowchart that describes a method performed by the network node 120 for determining interoperability of the updated version of the piece of software with the device 110 according to embodiments herein.

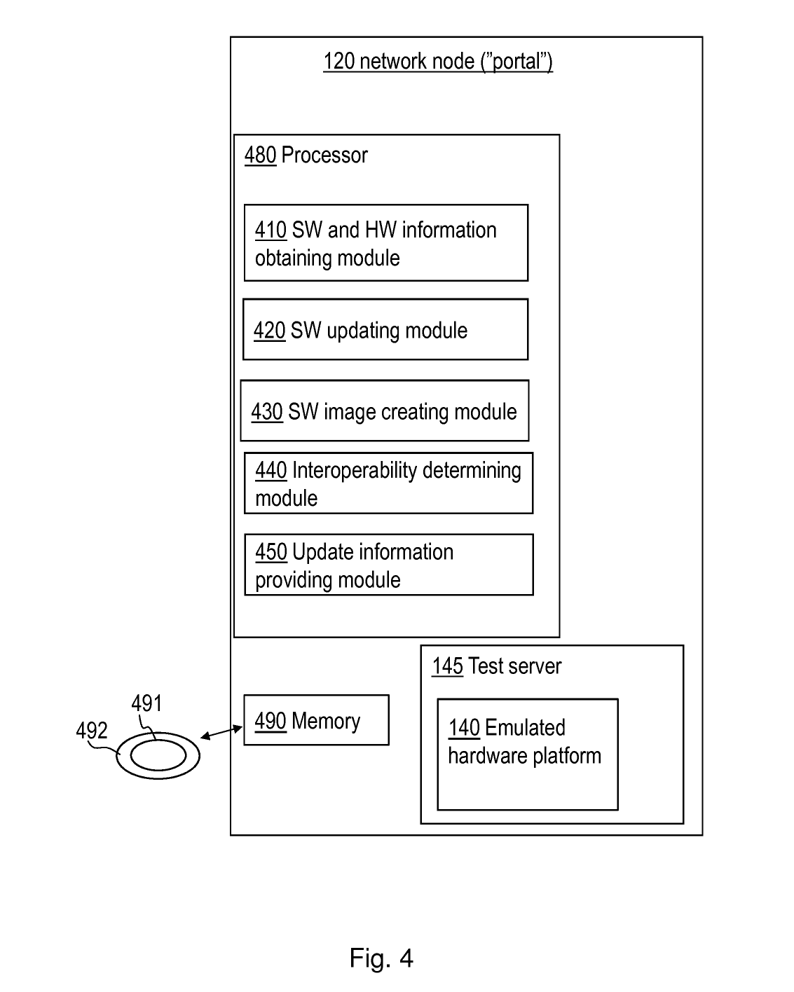

FIG. 4 is a flowchart that describes a method performed by the device 110 for assisting the network node 120 in determining interoperability of the updated version of the piece of software with the device 110 according to embodiments herein. The actions below will be described both in relation to embodiments according to

FIG. 1b and in relation to embodiments according to FIG. 1c.

### Actions 201, 301, 501

Some of the software, e.g. the piece of software, comprised in the device 110 is to be updated. Thus the software comprised in the device 110 comprises the piece of software to be updated.

In order for the network node 120 to determine the interoperability of updated versions of software with the device 110 the network node 120 obtains information about software and hardware comprised in the device 110. The information about software comprises information about the piece of software.

The network node 120 may obtain information about software and hardware comprised in the device 110 directly from the device 110 through some sort of protocol. The network node 120 may further obtain information about software and hardware comprised in the device 110 indirectly from the device 110 e.g. with a Quick Response (QR) code. The QR code may be attached to the device 110 or a package for the device 110. The QR code may comprise information about software and hardware comprised in the device 110 or a link to information about software and hardware comprised in the device 110.

The network node 120 may further obtain information about software and hardware comprised in the device 110 from the external network 130, e.g. by entering a serial number or similar of the device 110 on a web site.

A SW and HW information obtaining module 410 in the network node 120 may perform actions 201 and 501, as illustrated in FIG. 4. In this document SW is an abbreviation for SoftWare and HW is an abbreviation for HardWare.

The device 110 provides information about software, which software comprises the piece of software to be updated, and hardware, each comprised in the device 110, to the network node 120. With the information about software and hardware the network node 120 is able to determine the interoperability of the updated version of the piece of software with the device 110 based on a result of an interoperability test of the piece of software in the emulated environment corresponding to the device 110. The emulated environment is created using updated information about software and hardware comprised in the device 110.

The information about software comprised in the device 110 may comprise information about where the network node 120 shall search for the updated version of the piece of software. The information about where the network node 120 shall search for the updated version of the piece of software may comprise a Universal Resource Locator URL to any one or more out of: a vendor and/or a manufacturer of the wireless communications device 110, and any one or more out of a vendor, a manufacturer and an open source repository of software comprised in the wireless communications device 110.

The information about where the network node 120 shall search for the updated version of the piece of software may allow the network node 120 or the test server 145 in the cloud to download the binary of the updated version of the piece software, e.g. an updated application running on the device, together with a test program, such as a test stimuli program, for the piece of software to be updated. In this case, the network node 120 or the test server 145 in the cloud may do much more thorough tests of the updated software together with the updated version of the other software, such as libraries, kernel, etc., to make sure the updated version is compatible with the device 110 before deploying the real update to the device 110.

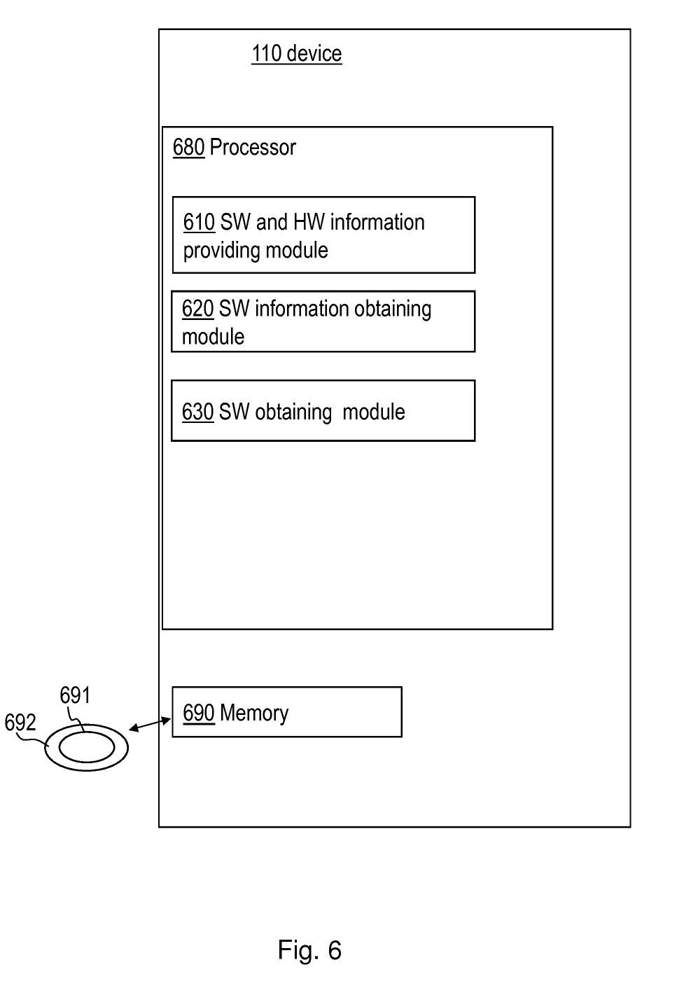

A SW and HW information providing module 610 in the device 110 may perform action 601, as illustrated in FIG. 6.

The following is an example of how the above actions may be implemented. When a new device, such as the device 110, is connected to the network 100, it may present itself, e.g. through a broadcast protocol, to the network node 120. This may be referred to as a fleet join request. The owner of the network 100 may, e.g. through the management interface of the network node 120, accept or decline the fleet join request, or the network node 120 may be configured to accept or decline new fleet join requests based on some criteria. E.g. the network node 120 may be configured to automatically accept new fleet join requests.

The device 110 may send a list of ingredients comprised in, or in other words a management manifest of, the device 110 with the fleet join request, or when the device 110 is part of the fleet of managed devices by the network node 120.

The list of ingredients may be a compilation of the versions of all the software comprised in the device and needed to run its applications; operating system, libraries, drivers et cetera. The list of ingredients may also comprise information about the hardware of the device so that the portal later may build a virtual machine that corresponds to the device.

In the list of ingredients or management manifest, there may also be URLs to where to look for updates as described above.

The network node 120 may keep a database of all necessary software for all devices of its fleet.

### Action 202

When the network node 120 has obtained the information about software and hardware comprised in the device 110 the network node 120 may search for updates, e.g. according to the suggestions in the obtained information about software as mentioned above in relation to actions 201, 301 and 501.

For example, the network node 120 may try to find updates for the software in its database, possibly using the URLs provided by the management manifests of the devices.

The search may be performed at a regular interval or based on a triggering event.

### Actions 203, 302

When the network node 120 finds an updated version of the piece of software, e.g. an updated library, used in the device 110, the network node 120 updates the information about software and hardware with information about the updated version of the piece of software. The updating may comprise obtaining information about the updated version of the piece of software. The network node 120 may e.g. obtain information about the updated version from the external network 130, using an URL suggested by the device 110 as mentioned above in relation to actions 201, 301 and 501.

In some embodiments the network node 120 also obtains the updated version of the piece of software. This may be the case when the network node 120 comprises the emulated environment, such as the test server 145. The network node 120 may download the updated version either in correct binary form or as source code and perform a compilation.

A SW updating module 420 in the network node 120 may perform actions 203 and 302, as illustrated in FIG. 4.

### Action 204

As mentioned above in relation to FIG. 1c, in some embodiments the network node 120 does not comprise the emulated environment, such as the test server 145. E.g. the network node 120 may not have the required means to do required compilations of software, or to build and run the emulated environment, such as the virtual machine, corresponding to the device. Then a cloud based extended version of the network node 120 comprising the test server 145 may be constructed. The network node 120 is in such a case responsible for monitoring the software updates and when it finds software that has a new version it will forward or upload updated information about software and hardware, i.e. an updated list of ingredients, to the test server 145. The updated information comprises information about the updated version of the piece of software to be updated.

The cloud service, i.e. the test server 145, may then create or build an updated image of the software, comprising the updated version of the piece of software to be updated, and instigate the emulated hardware platform 140, or virtual machine, corresponding to the hardware comprised in the device 110.

The test server 145 may perform cross-compilation, i.e. compiling for a target architecture different than the host architecture, and build the emulated environment and test the updated software for interoperability with the device 110.

### Actions 205, 303

In order for the network node 120 to create the emulated environment corresponding to the device 110 the network node 120 may create an updated image of software comprised in the device 110. The updated image of software comprises the updated version of the piece of software. For this purpose the network node 120 may obtain, e.g. by downloading, the updated version of the piece of software from the external network 130 if it hasn't done this in action 203 above. The network node 120 may e.g. obtain the correct binary of the updated version of the piece of software.

For the same purpose the network node 120 may also download or retrieve from a local cache the rest of the software comprised in the device 110, such as other necessary software packages for the device 110, according to the information about software and hardware. In practice, the network node 120 may search and fetch the list of ingredients that comprises the updated software.

The network node 120 may obtain the software comprised in the device 110 from the external network 130, such as the Internet, and/or from the device 110.

In the embodiments where the network node 120 does not comprise the emulated hardware platform 140, as described above in relation to FIG. 1c, the cloud based service comprising the emulated hardware platform 140 may create the updated image in a similar manner as described above.

A SW image creating module 430 in the network node 120 may perform actions 205 and 303, as illustrated in FIG. 4.

### Actions 206, 304

In the embodiments where the network node comprises the emulated hardware platform 140 the network node 120 may perform the interoperability test itself.

In the embodiments where the network node 120 does not comprise the emulated hardware platform 140, the test server 145, e.g. comprised in the cloud based service, may create the updated image of software and perform the interoperability test.

In either case the network node 120 determines the interoperability of the updated version of the piece of software with the device 110 based on a result of the interoperability test of the piece of software in the emulated environment corresponding to the device 110 and created using updated information about software and hardware comprised in the device 110.

The interoperability test may comprise any one or more out of a link test, an execution test and a stimuli test.

In the case where the network node 120 does not comprise the emulated environment the network node 120 may obtain the test result from the test server 145 and also the correct binary of updated software.

Since the network node 120 determines the interoperability of the updated version of the piece of software before the updated software is actually deployed in the device 110 the device 110 will be free of incompatibility conflicts, without paying a premium in terms of persistent and/or volatile storage requirements.

Furthermore, since the network node 120 determines the interoperability of the updated version of the piece of software the device 110 does not need to regularly check for software updates itself, which improves the power consumption of the device 110 and allows the device 110 to be more power constrained.

An interoperability determining module 440 in the network node 120 may perform actions 206 and 304, as illustrated in FIG. 4.

### Actions 207, 305, 502

When the network node 120 has determined that the updated version of the software is interoperable with the device 110 the network node 120 provides information about the updated version of the piece of software to the device 110. The network node 120 may e.g. perform a delta update, i.e. the difference between the original and the new code or binary image, or similar.

An update information providing module 440 in the network node 120 may perform actions 207 and 305, as illustrated in FIG. 4.

Correspondingly, when the network node 120 has determined that the updated version of the software is interoperable with the device 110 the device 110 obtains information about the updated version of the piece of software from the network node 120.

A SW information obtaining module 620 in the device may perform action 502, as illustrated in FIG. 6.

### Actions 208, 503

When the device 110 knows about the available updated version of the piece of software the device 110 may obtain the updated piece of software based on the information about the updated version of the piece of software. The updated version of the software may be obtained from the network node 120 and/or from the external network 130.

A SW obtaining module 630 in the device may perform action 208, as illustrated in FIG. 6.

### Action 209

In some embodiments the device 110 acknowledges the update to the network node 120.

### Action 210

The network node 120 may update its internal database of software version for the device 110 to include the updated version of the piece of software. The update of the information about the software may be triggered by the acknowledgement of the update from the device 110 received above in action 209.

To perform the method actions for determining interoperability of the updated version of the piece of software with the device 110 in the network 100 described above in relation to FIG. 2 and FIG. 3, the network node 120 comprises the following arrangement depicted in FIG. 4.

As mentioned above the emulated environment may comprise an emulated hardware platform 140 corresponding to the hardware comprised in the device 110 and onto which emulated hardware platform 140 software comprised in the device (110) is loaded. The emulated environment may be implemented by the test server 145.

The network node 120 may be wall-powered and/or easily re-chargeable.

The network node 120 is configured to, e.g. by means of the SW and HW information obtaining module 410 configured to, obtain information about software and hardware comprised in the device 110, which software comprises the piece of software to be updated.

The SW and HW information obtaining module 410 may be implemented by a processor 480 in the network node 120.

The network node 120 is further configured to, e.g. by means of the SW updating module 420 configured to, update information about software and hardware with information about the updated version of the piece of software.

The SW updating module 420 may be implemented by the processor 480 in the network node 120.

The network node 120 is further configured to, e.g. by means of the interoperability determining module 440 configured to, determine the interoperability of the updated version of the piece of software with the device 110 based on the result of the interoperability test of the piece of software in the emulated environment corresponding to the device 110 and created using the updated information about software and hardware comprised in the device 110.

The network node 120 may further be configured to, e.g. by means of the interoperability determining module 440 configured to, perform the interoperability test.

The interoperability determining module 440 may be implemented by the processor 480 in the network node 120.

The network node 120 may be further configured to, e.g. by means of the SW image creating module 430 configured to, create an updated image of software comprised in the device 110. The updated image of software comprises the updated version of the piece of software.

The SW image creating module 430 may be implemented by the processor 480 in the network node 120.

The network node 120 may be further configured to, e.g. by means of the update information providing module 450 configured to, provide information about the updated version of the piece of software to the device 110 when the updated version of the piece of software has been determined to be interoperable with the device 110.

The update information providing module 450 may be implemented by the processor 480 in the network node 120.

Those skilled in the art will also appreciate that the SW and HW information obtaining module 410, the SW updating module 420, the SW image creating module 430, the interoperability determining module 440 and the update information providing module 450 described above may refer to a combination of analogue and digital circuits, and/or one or more processors configured with software and/or firmware, e.g. stored in a memory 490 that when executed by the one or more processors such as the processor 480 perform as described above. One or more of these processors, as well as the other digital hardware, may be included in a single ASIC, or several processors and various digital hardware may be distributed among several separate components, whether individually packaged or assembled into a SoC.

The network node 120 may further be configured to, e.g. by means of the memory 490 configured to, store for example information about software and hardware, information about the updated version of the piece of software, updated information about software and hardware, test programs, test results and configurations, schedulings and applications etc. to perform the methods herein when being executed in the network node 120. The memory 490 comprises one or more memory units.

The embodiments herein for determining interoperability of the updated version of the piece of software with the device 110 in the network 100 may be implemented through one or more processors, such as the processor 480 in the network node 120 depicted in FIG. 4, together with a computer program 491, comprising instructions that, when executed on the processor 480, cause the processor 480 to carry out the functions and actions of the embodiments herein.

The computer program 491 mentioned above may also be provided as a computer program product for instance in the form of a carrier 492 comprising the computer program 491 for performing the embodiments herein when being loaded into the network node 120. Such a carrier may be an electronic signal, optical signal, radio signal, or a computer readable storage medium, e.g. in the form of a CD ROM disc.

It is however feasible with other data carriers such as a memory stick. The computer program code may furthermore be provided as pure program code on a server and downloaded to the network node 120.

Thus, the methods according to the embodiments described herein for the network node 120 may be implemented by means of a computer program product, comprising instructions, i.e., software code portions, which, when executed on at least one processor, cause the at least one processor to carry out the actions described herein, as performed by the network node 120. The computer program product may be stored on a computer-readable storage medium. The computer-readable storage medium, having stored there on the computer program, may comprise the instructions which, when executed on at least one processor, cause the at least one processor to carry out the actions described herein, as performed by the network node 120. In some embodiments, the computer-readable storage medium may be a non-transitory computer-readable storage medium.

To perform the method actions for assisting the network node 120 in determining interoperability of the updated version of the piece of software with the device 110 in the network 100 described above in relation to FIG. 2 and FIG. 5, the network node 120 comprises the following arrangement depicted in FIG. 6.

The device 110 is configured to, e.g. by means of the SW and HW information providing module 610 configured to, provide information about software, which software comprises the piece of software to be updated, and hardware, each comprised in the device 110, to the network node 120. With the information the network node 120 is able to determine the interoperability of the updated version of the piece of software with the device 110 based on a result of an interoperability test of the piece of software in an emulated environment corresponding to the device 110 and created using the updated information about software and hardware comprised in the device 110.

The information about software comprised in the device 110 may comprise information about where the network node 120 shall search for the updated version of the piece of software.

The SW and HW information providing module 610 may be implemented by a processor 680 in the device 110.

The device 110 may further be configured to, e.g. by means of the SW information obtaining module 620 configured to, obtain information about the updated version of the piece of software from the network node 120 when the updated version of the piece of software has been determined to be interoperable with the device 110, wherein the determination is based on the result of the interoperability test of the piece of software in the emulated environment corresponding to the device 110.

The SW information obtaining module 620 may be implemented by the processor 680 in the device 110.

The device 110 may further be configured to, e.g. by means of the SW obtaining module 630 configured to, obtain the updated piece of software based on the information about the updated version of the piece of software.

The SW obtaining module 630 may be implemented by the processor 680 in the device 110.

Those skilled in the art will also appreciate that SW and HW information providing module 610, the SW information obtaining module 620 and SW obtaining module 630 described above may refer to a combination of analogue and digital circuits, and/or one or more processors configured with software and/or firmware, e.g. stored in a memory 690 that when executed by the one or more processors such as the processor 680 perform as described above. One or more of these processors, as well as the other digital hardware, may be included in a single ASIC, or several processors and various digital hardware may be distributed among several separate components, whether individually packaged or assembled into a SoC.

The device 110 may further be configured to, e.g. by means of the memory 690 configured to, store for example information about software and hardware, information about the updated version of the piece of software, updated information about software and hardware, and configurations, schedulings and applications etc. to perform the methods herein when being executed in the device 110. The memory 690 comprises one or more memory units.

The embodiments herein for assisting the network node 120 in determining interoperability of the updated version of the piece of software with the device 110 in the network 100 may be implemented through one or more processors, such as the processor 680 in the device 110 depicted in FIG. 6, together with a computer program 691, comprising instructions that, when executed on the processor 680, cause the processor 680 to carry out the functions and actions of the embodiments herein.

The computer program 691 mentioned above may also be provided as a computer program product for instance in the form of a carrier 692 comprising the computer program 691 for performing the embodiments herein when being loaded into the device 110. Such a carrier may be an electronic signal, optical signal, radio signal, or a computer readable storage medium, e.g. in the form of a CD ROM disc.

It is however feasible with other data carriers such as a memory stick. The computer program code may furthermore be provided as pure program code on a server and downloaded to the device 110.

Thus, the methods according to the embodiments described herein for the device 110 may be implemented by means of a computer program product, comprising instructions, i.e., software code portions, which, when executed on at least one processor, cause the at least one processor to carry out the actions described herein, as performed by the device 110. The computer program product may be stored on a computer-readable storage medium. The computer-readable storage medium, having stored there on the computer program, may comprise the instructions which, when executed on at least one processor, cause the at least one processor to carry out the actions described herein, as performed by the device 110. In some embodiments, the computer-readable storage medium may be a non-transitory computer-readable storage medium.

When using the word “comprise” or “comprising” it shall be interpreted as non-limiting, i.e. meaning “consist at least of”.

Modifications and other embodiments of the disclosed embodiments will come to mind to one skilled in the art having the benefit of the teachings presented in the foregoing descriptions and the associated drawings. Therefore, it is to be understood that the embodiment(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

Therefore, the above embodiments should not be taken as limiting the scope, which is defined by the appending claims.

Also note that terminology such as a first network node and a second network node should be considered to be non-limiting and does in particular not imply a certain hierarchical relation between the two.

1. A method performed by a network node for determining interoperability of an updated version of a piece of software with a device, which network node and which device operate in a network, the method comprising:
obtaining information about software and hardware comprised in the device, which software comprises the piece of software to be updated,
updating information about software and hardware with information about the updated version of the piece of software, and
determining the interoperability of the updated version of the piece of software with the device based on a result of an interoperability test of the piece of software in an emulated environment corresponding to the device and created using updated information about software and hardware comprised in the device.

2. The method according to claim 1, wherein the emulated environment comprises an emulated hardware platform corresponding to the hardware comprised in the device and onto which emulated hardware platform software comprised in the device is loaded.

3. The method according to claim 1, wherein the interoperability test comprises any one or more out of a link test, an execution test and a stimuli test.

4. The method according to claim 1, further comprising:
creating an updated image of software comprised in the device, which updated image of software comprises the updated version of the piece of software, and performing the interoperability test.

5. The method according to claim 1, wherein the information about software comprised in the device comprises information about where the network node shall search for the updated version of the piece of software.

6. The method according to claim 1, further comprising providing information about the updated version of the piece of software to the device when the updated version of the piece of software has been determined to be interoperable with the device.

7. The method according to claim 1, wherein the network node is wall-powered and/or easily re-chargeable.

8. A network node for determining interoperability of an updated version of a piece of software with a device, which network node and which device are configured to operate in a network, the network node is configured to:
obtain information about software and hardware comprised in the device, which software comprises the piece of software to be updated,
update information about software and hardware with information about the updated version of the piece of software, and
determine the interoperability of the updated version of the piece of software with the device based on a result of an interoperability test of the piece of software in an emulated environment corresponding to the device and created using updated information about software and hardware comprised in the device.

9. The network node according to claim 8, wherein the emulated environment comprises an emulated hardware platform corresponding to the hardware comprised in the device and onto which emulated hardware platform software comprised in the device is loaded.

10. The network node according to claim 8, wherein the interoperability test comprises any one or more out of a link test, an execution test and a stimuli test.

11. The network node according to claim 8, further configured to:
create an updated image of software comprised in the device, which updated image of software comprises the updated version of the piece of software, and perform the interoperability test.

12. The network node according to claim 8, wherein the information about software comprised in the device comprises information about where the network node shall search for the updated version of the piece of software.

13. The network node according to claim 8, further configured to provide information about the updated version of the piece of software to the device when the updated version of the piece of software has been determined to be interoperable with the device.

14. The network node according to claim 8, wherein the network node is wall-powered and/or easily re-chargeable.

15. A method performed by a device for assisting a network node in determining interoperability of an updated version of a piece of software with the device, which network node and which device operate in a network, the method comprising:
providing information about software, which software comprises the piece of software to be updated, and hardware, each comprised in the device, to the network node, with which information the network node is able to determine the interoperability of the updated version of the piece of software with the device based on a result of an interoperability test of the piece of software in an emulated environment corresponding to the device and created using updated information about software and hardware comprised in the device.

16. The method according to claim 15, wherein the information about software comprised in the device comprises information about where the network node shall search for the updated version of the piece of software.

17. The method according to claim 15, further comprising:
obtaining information about the updated version of the piece of software from the network node when the updated version of the piece of software has been determined to be interoperable with the device, wherein the determination is based on the result of the interoperability test of the piece of software in the emulated environment corresponding to the device, and
obtaining the updated piece of software based on the information about the updated version of the piece of software.

18. The method according to claim 15, wherein the device is power constrained.

19. A device for assisting a network node in determining interoperability of an updated version of a piece of software with the device, which network node and which device operate in a network, the device is configured to:
provide information about software, which software comprises the piece of software to be updated, and hardware, each comprised in the device, to the network node with which information the network node is able to determine the interoperability of the updated version of the piece of software with the device based on a result of an interoperability test of the piece of software in an emulated environment corresponding to the device and created using updated information about software and hardware comprised in the device.

20. The device according to claim 19, wherein the information about software comprised in the device comprises information about where the network node shall search for the updated version of the piece of software.

21. The device according to claim 19, further configured to:
obtain information about the updated version of the piece of software from the network node when the updated version of the piece of software has been determined to be interoperable with the device, wherein the determination is based on the result of the interoperability test of the piece of software in the emulated environment corresponding to the device, and
obtain the updated piece of software based on the information about the updated version of the piece of software.

22. The device according to claim 19, wherein the device is power constrained.

23. A nontransitory processor-readable storage medium, comprising instructions that, when executed on at least one processor, cause the at least one processor to carry out a method performed by a network node for determining interoperability of an updated version of a piece of software with a device, which network node and which device operate in a network, the method comprising:
obtaining information about software and hardware comprised in the device, which software comprises the piece of software to be updated,
updating information about software and hardware with information about the updated version of the piece of software, and
determining the interoperability of the updated version of the piece of software with the device based on a result of an interoperability test of the piece of software in an emulated environment corresponding to the device and created using updated information about software and hardware comprised in the device.

24. (canceled)

25. A nontransitory processor-readable storage medium, comprising instructions that, when executed on at least one processor, cause the at least one processor to carry out a method performed by a device for assisting a network node in determining interoperability of an updated version of a piece of software with the device, which network node and which device operate in a network, the method comprising:
providing information about software, which software comprises the piece of software to be updated, and hardware, each comprised in the device, to the network node, with which information the network node is able to determine the interoperability of the updated version of the piece of software with the device based on a result of an interoperability test of the piece of software in an emulated environment corresponding to the device and created using updated information about software and hardware comprised in the device.

26. (canceled)

27. A method performed by a network system for determining interoperability of an updated version of a piece of software with a device, which network system and which device operates in a network 4404, wherein the network system comprises a network node and a test server, and wherein:
the network node obtains information about software and hardware comprised in the device, which software comprises the piece of software to be updated,
the network node updates information about software and hardware with information about the updated version of the piece of software,
the test server performs an interoperability test of the piece of software in an emulated environment corresponding to the device and created using the updated information about software and hardware comprised in the device, and
the network node determines the interoperability of the updated version of the piece of software with the device based on a result of the interoperability test.

28. A network system for determining interoperability of an updated version of a piece of software with a device, which network system and which device are configured to operate in a network, wherein the network system comprises a network node and a test server, and wherein:
the network node is configured to obtain information about software and hardware comprised in the device, which software comprises the piece of software to be updated,
the network node is configured to update information about software and hardware with information about the updated version of the piece of software,
the test server is configured to perform an interoperability test of the piece of software in an emulated environment corresponding to the device and created using the updated information about software and hardware comprised in the device, and
the network node is configured to determine the interoperability of the updated version of the piece of software with the device based on a result of the interoperability test.
